(19) United States
(12) Patent Application Publication
(10) Pub. No.: US 2011/0300048 A1
(43) Pub. Date: Dec. 8, 2011

(54) METHOD FOR RECYCLING SILICON CARBIDE

(76) Inventors: Yu-Lung SUN, Kaohsiung City (TW); Yung-Hao LIU, Kaohsiung City (TW)

(21) Appl. No.: 12/833,652

(22) Filed: Jul. 9, 2010

(30) Foreign Application Priority Data
Jun. 4, 2010 (TW) 099118261

(51) Int. Cl. C01B 31/36

(52) U.S. Cl. 423/345

(57) ABSTRACT

A method for recycling silicon carbide, comprises a filtrating step, providing a siliceous mortar with silicon carbide, silicon and a buffer, and further filtering out the buffer form the siliceous mortar to obtain a siliceous slurry; a first removing step, heating the siliceous slurry to evaporate the buffer and obtain a mixture of silicon and silicon carbide; a dissolving step, placing the mixture of silicon and silicon carbide in an alkaline solution to dissolve the silicon from the mixture of silicon and silicon carbide into the alkaline solution; and a second removing step, completely removing the alkaline solution containing dissolved silicon, in order to obtain purified silicon carbide.

### BACKGROUND OF THE INVENTION

1. Field of the Invention

The present invention relates to a recycling method, particularly to a method for recycling silicon carbide.

2. Description of the Related Art

Currently, silicon chips are widely applied to solar industry and the electronic industry for further manufacturing. Generally, the silicon chips are obtained from the process of slicing up the silicon bar wherein, a sliced oil such as polyethylene glycols (also called PEG), may be usually used accompanying by a slice to scour the debris produced while slicing. In this situation, some siliceous mortar containing silicon carbide, silicon, the sliced oil and the debris of the slice may be produced due to the lost of the silicon bar and slice from the slicing process. However, directly abandoning the silicon mortar may lead to not only the waste of the raw materials, also the pollution on natural environment. Therefore, some research institutions have endeavored to develop a powerful technique for significant recycling silicon and silicon carbide from the silicon mortar.

The conventional technique for recycling silicon carbide usually dilute the silicon mortar by adding a great amount of assistant, such as water or organic solvents, followed up filtering out the sliced oil and assistant by processing of repeatedly filtration to obtained solid silicon or silicon carbide. After that, a further process may be needed to isolate the sliced oil from the assistant to recycle the sliced oil.

Nevertheless, due to the complexity of the processes of the conventional technique, a significant amount of energy is needed during the recycling process so that the cost of the recycling process may be dramatically increased, and also the characteristics of the sliced oil may be affected after the long-term of process.

Generally, the separation of the solid silicon and silicon carbide are successfully been processed undergone different strategies like high-temperature separation, heavy-liquid separation and foam flotation.

In the high-temperature separation, due to the difference of melt point between silicon (2545° C.) and silicon carbide (1412° C.), it is sufficient to separate silicon and silicon carbide under a high temperature. However, a great amount of energy is needed while heating the solid silicon and silicon carbide by an electric stove, which may advance the cost, also the pollution. As a result, the high-temperature separation is less efficiently in use.

In the heavy-liquid separation, the solid silicon and silicon carbide are incubated in an organic solvent with a density between the density of silicon and silicon carbide, such as chloroform. As following, a high-speed centrifugation is performed to separate the solid silicon and silicon carbide via various densities between silicon, silicon carbide and the organic solvent wherein silicon, with highest density among three, will suspense on the top of the organic solvent and silicon carbide, with the lowest density will precipitate. In this way, the solid silicon and silicon carbide are successfully separated. However, the organic solvent used in the heavy-density separation is quite harmful whatever to animals or natural environment. Also, the law flash point of the organic solvent may easily trigger off some accidents during the operating process. Furthermore, the cost of the heavy-density separation is also high according to the use of the centrifuged equipment.

In the foam flotation, a surfactant is used to increase the surface of the solid silicon and silicon carbide and further produce some foam. According to the higher avidity of the solid silicon carbide to the surfactant, silicon carbide will be absorbed of the foam and kept at the top but the solid silicon will precipitate to the foot. In this way the solid silicon and silicon carbide can be separated. However, similar to the organic solvents, the surfactant is also harmful to animal and ecology, which may result in environmental pollution or accidents during the process.

Hence, there is an urgent need of improving the conventional technique for recycling silicon carbide.

### SUMMARY OF THE INVENTION

The primary objective of this invention is to provide a method for recycling silicon carbide, which can avoid the deterioration of the buffer caused by assistant in the siliceous mortar.

The secondary objective of this invention is to the method for recycling silicon carbide, which can sufficiently isolate silicon carbide without using any organic solvents.

Another objective of this invention is to the method for recycling silicon carbide, which can sufficiently isolate silicon carbide without using centrifuge.

A method for recycling silicon carbide, comprises a filtrating step, providing a siliceous mortar with silicon carbide, silicon and a buffer, and further filtering out the buffer form the siliceous mortar to obtain a siliceous slurry; a first removing step, heating the siliceous slurry to evaporate the buffer and obtain a mixture of silicon and silicon carbide; a dissolving step, placing the mixture of silicon and silicon carbide in an alkaline solution to dissolve the silicon from the mixture of silicon and silicon carbide into the alkaline solution; and a second removing step, completely removing the alkaline solution containing dissolved silicon, in order to obtain purified silicon carbide

Further scope of the applicability of the present invention will become apparent from the detailed description given hereinafter. However, it should be understood that the detailed description and specific examples, while indicating preferable embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram illustrating of the method for recycling silicon carbide in the first embodiment;

FIG. 2 is a diagram illustrating of the method for recycling silicon carbide in the second embodiment;

In the various figures of the drawings, the same numerals designate the same or similar parts. Furthermore, when the term “first”, “second” and similar terms are used hereinafter, it should be understood that these terms are reference only to the structure shown in the drawings as it would appear to a person viewing the drawings and are utilized only to facilitate describing the invention.

### DETAILED DESCRIPTION OF THE INVENTION

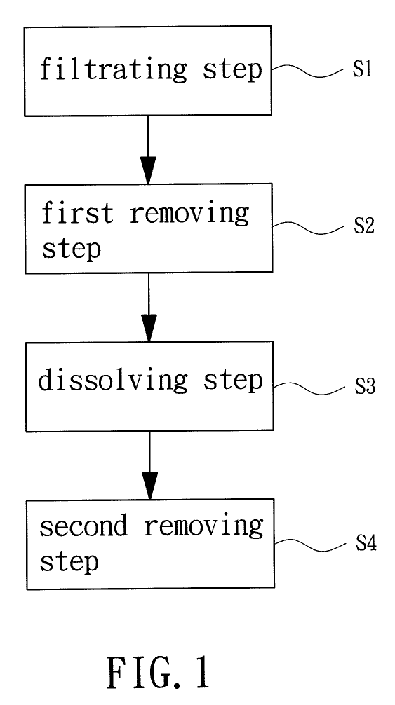

Referring to FIG. 1, in accordance with a first embodiment of the method for recycling silicon carbide in the present invention comprises a filtrating step S1, a first removing step S2, a dissolving step S3 and a second removing step S4.

In the filtrating step S1, siliceous mortar containing silicon carbide, silicon, and a buffer is prepared and further filtered out the buffer to obtain a siliceous slurry. For more precisely, the siliceous mortar is collected from a waste liquid produced during a slicing process of silicon bar, which may also contain some impurity, such as iron filing or other metal filing from the lost of a slice used in the slicing process. The buffer is selected form general slicing solutions, PEG for example. In the first embodiment, the buffer in the siliceous mortar is filtered out via a filtration machine or a membrane filtration machine to obtain the siliceous slurry containing silicon carbide and silicon. In the filtrating step S1, only a primary filtrated process is performed to separate solid material (means silicon and silicon carbide) and liquid buffer, and therefore, an assistant is no longer added to the siliceous mortar. Accordingly, the cost of the process is decreased, the separated liquid buffer can be directly recycled, and the deterioration of the assistant will no longer be happened.

Sometimes, the separated solid silicon carbide and silicon may still carry some impurities like iron filing, and therefore, it is preferable to soak the separated solid silicon carbide and silicon in an acid solution, such a hydrochloric acid, a nitric acid, sulfuric acid, hydrofluoric acid or a mixture of them. In this situation, the impurities can be removed via dissolving the impurities in the acid solution and further exhausting the acid solution, by filtration for example. It is preferable for the acid solution to further contain an assistant, such as hydrogen peroxide, in order to promote the efficient of solubility of the acid solution. As an example, 2M of sulfuric acid and 1 wt % of hydrogen peroxide are mixed and used as an acid solution in the present invention.

In the first removing step S2, the siliceous slurry is heated till the buffer has complete evaporated and a mixture of silicon and silicon carbide will be obtained. For more precisely, in the filtrating step S1, only a primary separation of liquid from solid is processed, and therefore a plenty amount of the buffer may still remain on the siliceous slurry. As a result, a further removing process will be need to complete evaporate the buffer. For example, in the first embodiment in the present invention the siliceous slurry is distally heated by a stove under a circumstance of up to 250° C. in order to complete evaporate the buffer, also to obtain the mixture of silicon and silicon carbide. Also, the evaporated buffer may be collected and recycled via a congealing reaction.

In the dissolving step S3, the mixture of silicon and silicon carbide is placed in an alkaline solution for dissolving the silicon from the mixture of silicon and silicon carbide. For more precisely, for specifically isolating silicon, it is preferable to soak the mixture of silicon and silicon carbide in the alkaline solution, such as NaOH, NH₄OH, KOH or a mix of them. As an example, 2M of NaOH solution is selected as the alkaline solution in the first embodiment of the present invention to dissolve the silicon in the mixture of silicon and silicon carbide in the NaOH solution. In this situation a sodium silicate solution will be obtained in this step.

In the second removing step S4, the sodium silicate solution is removed to obtain a purified silicon carbide. For more precisely, the sodium silicate solution containing the dissolved silicon from the mixture of silicon and silicon carbide is removed via filtration. Additionally, for complete removing the sodium silicate solution, it is preferable to wash the purified silicon carbide by water. In this way, the purified silicon carbide can be obtained via the method for recycling silicon carbide.

Furthermore, a silica gel may be also obtained in the present invention by acidifying the removed sodium silicate solution. For example, in the first embodiment, it is sufficient to precipitate the silica gel via adding the acid solution as mentioned before or aerating carbon dioxide into the sodium silicate solution. In this way, the silica gel can be isolated and further recycled. Sometime, for complete separating the acid solution from the silica gel, it is preferable to wash the silica gel by an electrolyte followed by baking under an circumstance of 300° C. for 2 hours. Hence, the silica or silica gel can be finally collected. In this way, it is less wasting on raw material by converting the dissolved silicon from the sodium silicate solution into silica or silica gel.

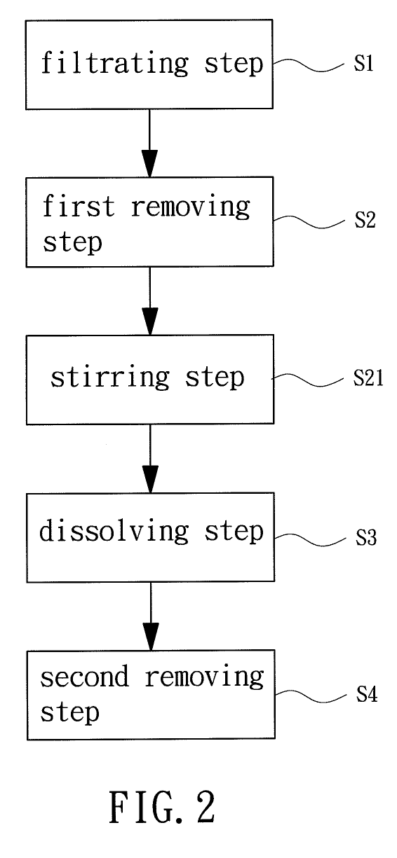

Referring to FIG. 2, in accordance with a second embodiment of the method for recycling silicon carbide in the present invention comprises a filtrating step S1, a first removing step S2, a stirring step S21, a dissolving step S3 and a second removing step S4 wherein the filtrating step S1, first removing step S2, dissolving step S3 and the second removing step S4 are the same as the process in the first embodiment.

In the stirring step S21, the mixture of silicon and silicon carbide obtained from the first removing step S2 is added into a liquid-substrate followed by stirring and incubating for a while to obtain a sedimentation of the mixture of silicon and silicon carbide and a suspension which contain suspended silicon and the liquid-substrate. As following, the sedimentation of the mixture of silicon and silicon carbide will be isolated for process of the dissolving step S3. For more precisely, the pH of the liquid-substrate used in the second embodiment is lower than pH 2.5 or higher than pH 3.5. Also, the mixture of silicon and silicon carbide is stirred and kept in the liquid-substrate under a rotation speed of 25 rpm. In this way, according the electric repulsion between silicon and silicon carbide, the silicon and the silicon carbide can be fast disjoined from each other in the liquid-substrate. Also, due to the difference of density between silicon and silicon carbide, the silicon carbide can be faster precipitated in the liquid substrate for primary isolation of silicon carbide. As a result, the precipitated silicon carbide can be collected and further applied to the following step.

On the other hand, the suspension obtained from the stirring step S21 can further be used to collect silicon powders by filtration. As an example, in the second embodiment of the present invention, it is preferable to filter off the liquid-substrate by using a membrane filter to recycle the silicon powders. Moreover, for further removing some impurities, such as iron filing, on the silicon powders, it is preferable to further wash the silicon powders with an acid buffer. For example, 20 wt % of sulfuric acid is used in the present invention to wash the impurities on the silicon powders. Sometime, some impurities may be covered with silicon powders so that it is less possible to be dissolved and mashed by the acid buffer. In this situation, it is preferable to further apply an electromagnet to the silicon powders, with a strong electromagnetic power to magnetic separated the impurities covered by silicon powders. As an example, 2 T (Tesla) of electromagnetic field is used in the second embodiment to magnetic separated the covered impurities in a more efficient manner. Hence, a high purity of the silicon powders can be obtained for recycling.

Through the present invention, the assistant will no longer be used in the filtrating step S1, and according the cost and energy can be saved. Meanwhile, the deterioration of the recycled buffer caused by assistant will not happen any more.

Also, in the present invention the silica or silica gel can be obtained via the acidification of the sodium silicate solution collected from the dissolving step S3.

Furthermore, with the process of the stirring step S21, it is sufficient to primary separated silicon carbide from silicon due to the difference of particle size or density between silicon and silicon carbide. Therefore, expensive equipments or organic solvents, like centrifuge, may not be needed to separate silicon and silicon carbide. In this situation, the cost and the consumed material of the recycling can be significantly decreased.

In summary, with the method for recycling silicon carbide in the present invention is beneficial to promote the recycling rate and to reduce the cost and consume of raw materials. In additional, it is more efficiency to recycle silicon carbide, silicon and buffer at the same time.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A method for recycling silicon carbide, comprising:
a filtrating step, providing a siliceous mortar with silicon carbide, silicon and a buffer, and further filtering out the buffer form the siliceous mortar to obtain a siliceous slurry;
a first removing step, heating the siliceous slurry to evaporate the buffer and obtain a mixture of silicon and silicon carbide;
a dissolving step, placing the mixture of silicon and silicon carbide in an alkaline solution to dissolve the silicon from the mixture of silicon and silicon carbide into the alkaline solution; and
a second removing step, completely removing the alkaline solution containing dissolved silicon, in order to obtain purified silicon carbide.

2. The method for recycling silicon carbide as defined in claim 1, wherein a placing step is performed after the first removing step, adding an acid solution and sequentially filtering out the acid solution from the mixture of silicon and silicon carbide to obtain a pure mixture of silicon and silicon carbide.

3. The method for recycling silicon carbide as defined in claim 1, wherein a stirring step is performed after the first removing step, placing the mixture of silicon and silicon carbide in a liquid-substrate followed by stirring and incubating for a while to obtain a sedimentation of the mixture and a suspension containing the liquid-substrate and silicon, and further isolating the mixture of silicon and silicon carbide to process the dissolving step.

4. The method for recycling silicon carbide as defined in claim 3, wherein an additional filtering step is performed after the stirring step to filter out the liquid-substrate from the suspension to obtain silicon powders.

5. The method for recycling silicon carbide as defined in claim 4, wherein a purifying step is performed after the additional filtering step, with acid solution to dissolve and further eliminate some impurity in silicon powders.

6. The method for recycling silicon carbide as defined in claim 5, wherein an electromagnet is applied to the acid solution while the silicon powders are added in the acid solution to magnetically eliminate some impurities covered by silicon powders.

7. The method for recycling silicon carbide as defined in claim 1, wherein an acidic precipitation step is performed after the second removing step, the removing alkaline solution containing dissolved silicon to produce silica gel.

8. The method for recycling silicon carbide as defined in claim 7, wherein a wash-baked step is performed after the acidic precipitation step, with an electrolyte to wash the silica gel followed by baking to obtain silica.

9. The method for recycling silicon carbide as defined in claim 3, wherein an adjusting step is performed before the stirring step to adjust the pH of the liquid-substrate to lower than pH 2.5 or upper than pH 3.5.
